(19) United States
(12) Patent Application Publication
(10) Pub. No.: US 2021/0008719 A1
(43) Pub. Date: Jan. 14, 2021

(54) INTERCONNECTING TILES FOR USE WITH LINE FOLLOWER ROBOTS

(71) Applicant: Genius Gems, LLC, Millburn, NJ (US)

(72) Inventors: Marc Romanoff, Millburn, NJ (US); Andrew Carter, Millburn, NJ (US); Jacob Wargon, Millburn, NJ (US)

(21) Appl. No.: 16/925,850

(22) Filed: Jul. 10, 2020

Related U.S. Application Data
(60) Provisional application No. 62/872,335, filed on Jul. 10, 2019.

(51) Int. Cl. B25J 9/16; B25J 13/08

(52) U.S. Cl. CPC B25J 9/1651; B25J 13/087; B25J 9/1694; B25J 9/1684; B25J 9/1664

(57) ABSTRACT

Systems and methods for line-following robots are disclosed. In exemplary embodiments, a line-following robot is configured to traverse one or more overlays that are fastened to a corresponding magnetic window tile. The magnetic window tiles are affixed to one another magnetically at adjacent edges. The line-following robot is configured to perceived visual indicators, such as lines, curves, and color patterns that determine how the line-following robot moves over window tiles.

### CROSS REFERENCE TO RELATED APPLICATION

The present application claims the benefit of and priority to U.S. Provisional Patent Application No. 62/872,335, entitled “INTERCONNECTING TILES FOR USE WITH LINE FOLLOWER ROBOTS,” filed on Jul. 10, 2019, the entire contents of which are incorporated by reference herein.

### FIELD

The invention relates to the field of robotics and, more specifically, to interconnecting tiles for use with line follower robots.

### BACKGROUND

Robots and robotic toys are widely used to foster the development of science, technology, engineering and mathematics (STEM) skills in children. For example, they can be used to teach computer programming and electronics. Many robots and robotic toys, such as the Ozobot® made by Evollve Inc., include light sensors that can be used to track and follow a line, e.g., a black line on a white background. Sensors can also be used to read codes drawn or applied by a user. For example, a series of colored lines, squares or dots can provide commands to the robot to move or change speed and direction.

These lines and codes are usually created by drawing on paper using markers or applying stickers that have the codes preprinted on them to paper. However, markers and paper can be messy and are consumables that constantly need to be replenished. Another problem is that users must draw the lines and codes precisely (e.g., just the right thickness and having the correct angles and curves). Otherwise, the line-following robot will not work, which can be frustrating to children and parents. Further, once a line or code is drawn, it cannot be erased, requiring the user to start from scratch (and throw away more paper) if a mistake is made or a new configuration is desired. Finally, the currently available materials and methods for constructing paths for line-follower robots are limited to two dimensions.

As such, there is a need for a new system and method for interacting with line-follower robots. Such a system and method would be particularly useful if it avoided the need for wasteful consumables and provided a reliable method for creating projects for use with line-follower robots. It would also be useful if such a system and method allowed for the construction of projects in three dimensions.

### SUMMARY

The invention relates to a system and method for interconnecting tiles to form paths for use with line-follower robots. The system may include: magnetic tiles that have open center portions (commonly referred to as window tiles) and overlays that snap into the window tiles that include printed lines, codes and/or ramps. Alternatively, the magnetic tiles may have lines, codes and ramps integrated into their structure.

In accordance with exemplary embodiments, a robotic system comprises a robot configured to move in two dimensions, a plurality of window tiles, each having fastened thereon an overlay, wherein each overlay has a surface on which is printed one or more corresponding visual indicators. The robot is further configured to sense the one or more visual indicators printed on the surface of the overlay as the robot moves over the surface of the overlay and, in response to sensing the one or more visual indicators, perform a predetermined action.

In accordance with exemplary embodiments, each of the plurality of window tiles has four outer sides, each outer side having configured thereon one or more magnets such that, when a pair of window tiles are placed in proximity to one another, the pair of window tiles are magnetically attracted to one another. In embodiments, at least one of the overlays has printed on its surface a straight line and, when the robot travels over the surface of the at least one of the overlays, the robot is further configured to sense the straight line and, in response to the sensing, move along the straight line. In embodiments, at least one of the overlays has printed on its surface a curved line and, when the robot travels over the surface of the at least one of the overlays, the robot is further configured to sense the curved line and, in response to the sensing, execute a turn to follow the curved line. In embodiments, at least one of the overlays has printed on its surface a color pattern and, when the robot travels over the surface of the at least one of the overlays, the robot is further configured to sense the color pattern and, in response to the sensing, execute one of a plurality of predetermined actions. In embodiments, the plurality of predetermined actions includes stopping, speeding up, slowing down, reversing motion, or emitting a sound.

In embodiments, at least one of the overlays has a first thickness at a first end and a second thickness at a second end, wherein the second thickness exceeds the first thickness, and wherein, when the robot travels over the surface of the at least one of the overlays, the robot moves in three dimensions.

In embodiments, one or more of the plurality of window tiles has a surface on which is integrated one or more visual indicators. In embodiments, at least one of the plurality of window tiles has integrated on its surface a straight line and, when the robot travels over the surface of the at least one of the window tiles, the robot is further configured to sense the straight line and, in response to the sensing, move along. In embodiments, at least one of the window tiles has integrated on its surface a curved line and, when the robot travels over the surface of the at least one of the window tiles, the robot is further configured to sense the curved line and, in response to the sensing, execute a turn to follow the curved line.

In embodiments, each of the plurality of overlays has a bottom surface on which is configured a plurality of tabs that are configured to be fastened to a receptacle on a corresponding surface of a window tile.

In accordance with exemplary embodiments, a method of constructing a path to be followed by a robot configured for two-dimensional motion and configured to perceive one or more visual indicators while in motion comprises selecting a first window tile; selecting a first overlay, the first overlay having a first surface that has printed thereon a first set of one or more visual indicators; fastening the first overlay to the first window tile; selecting a second window tile; selecting a second overlay, the second overlay having a second surface that has printed thereon a second set of one or more visual indicators; fastening the second overlay to the second window tile; affixing the first window tile to the second window tile such that the first and second set of visual indicators form a path that is capable of being perceived by the robot as the robot moves on the over the first and second surfaces of the first and second overlays.

In embodiments, fastening the first overlay to the first window tile comprises inserting one or more tabs on a bottom surface of the first overlay to one or more corresponding receptacles in a depression on a top surface of the window tile.

In embodiments, affixing the first window tile to the second window tile comprises placing a first edge of the first window tile adjacent to a second edge of the second window tile, wherein the first and second edges have embedded thereon one or more magnets.

In embodiments, the first overlay has a first thickness at a first end and a second thickness at a second end, the second thickness being greater than the first thickness, wherein, when the robot traverses the first overlay, the robot moves in three dimensions.

### DESCRIPTION OF THE DRAWINGS

Exemplary embodiments of the present invention will be described with references to the accompanying figures, wherein:

FIG. 1 is an illustration of a prior art method for constructing paths for use with a line-following robot;

FIG. 2 is an illustration of a magnetic tile for use with the system and method of the present invention;

FIGS. 3a-3f depict an overlay for use with the system and method of the present invention;

FIGS. 4a-4d depict additional overlays for use with the system and method of the present invention;

FIGS. 5a-5c depict a ramp overlay for use with the system and method of the present invention; and

FIG. 6 is depicts a track for a line-following robot constructed using the system and method of the present invention.

FIG. 7 depicts a flow diagram of an exemplary method of constructing a path to be followed by a robot configured for two-dimensional motion, according to embodiments of the present invention.

### DETAILED DESCRIPTION

Embodiments of the present invention will now be described with reference to the above-identified Drawings. However, the Drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

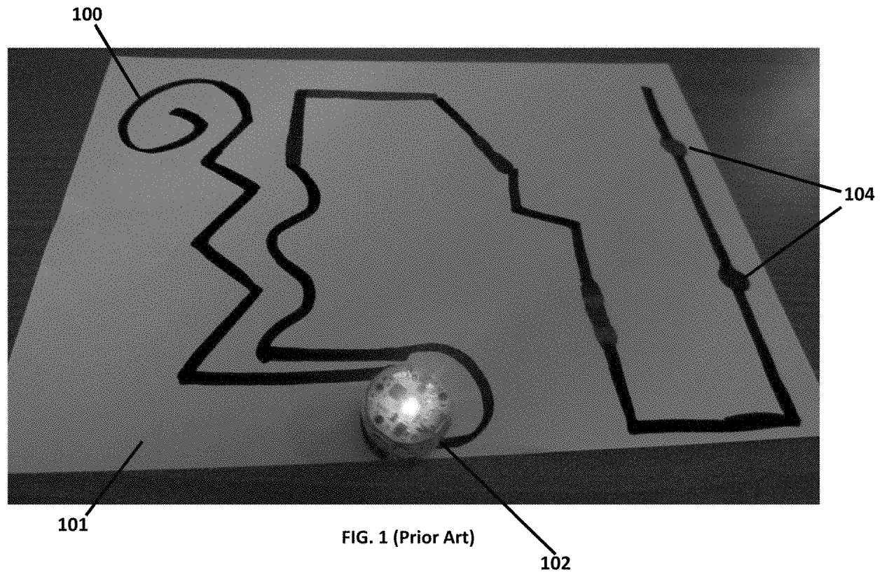

Shown in FIG. 1 is a prior art method for interacting with a line-follower robot. As can be seen, a path 100 consisting of lines, angles and curves has been drawn on a sheet of white paper 101 using a black marker. A line-following robot 102 travels over the depicted path 100 by using sensors and/or robotic vision to discern the path. In addition, a number of codes 104, comprising commands for the robot, have been added using colored markers. In use, the robot uses various sensors and/or robotic or computer vision to follow the lines and read the codes. However, as noted above, this design, including path 100 and codes 104, is fixed on paper 101 and cannot be readily modified.

It has been found that the shortcomings of the presently available techniques can be overcome by incorporating magnetic tiles into the design of paths and projects for use with line-follower robots. As is known, magnetic tiles are available in various shapes and sizes and generally have small magnets positioned around their periphery that allow them to be interconnected with other magnetic tiles.

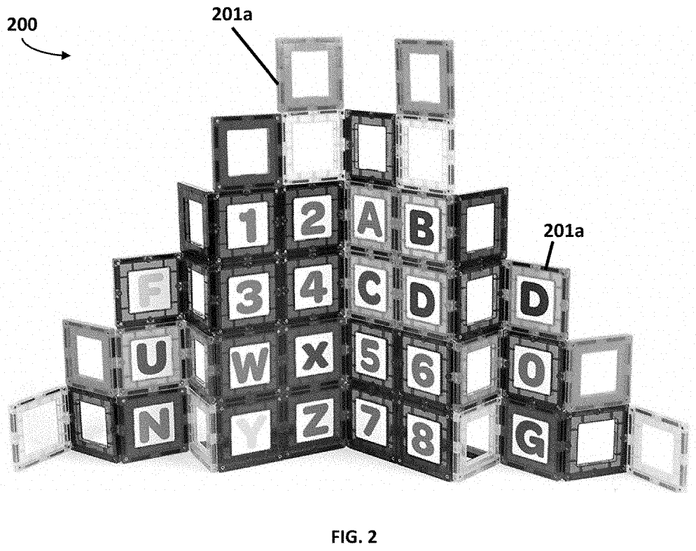

Shown in FIG. 2 is an exemplary magnetic tile building set 200. Each tile 201 in this particular set is a window tile, i.e., it has a square depression or opening in its center. These tiles are constructed such that letters, numbers, and other mathematic operators can be snapped into the center portion of the tiles. For example, tile 201a has an empty depression in its center. Tile 201b, on the other hand, has a member depicting the letter “D” snapped into the depression in its center.

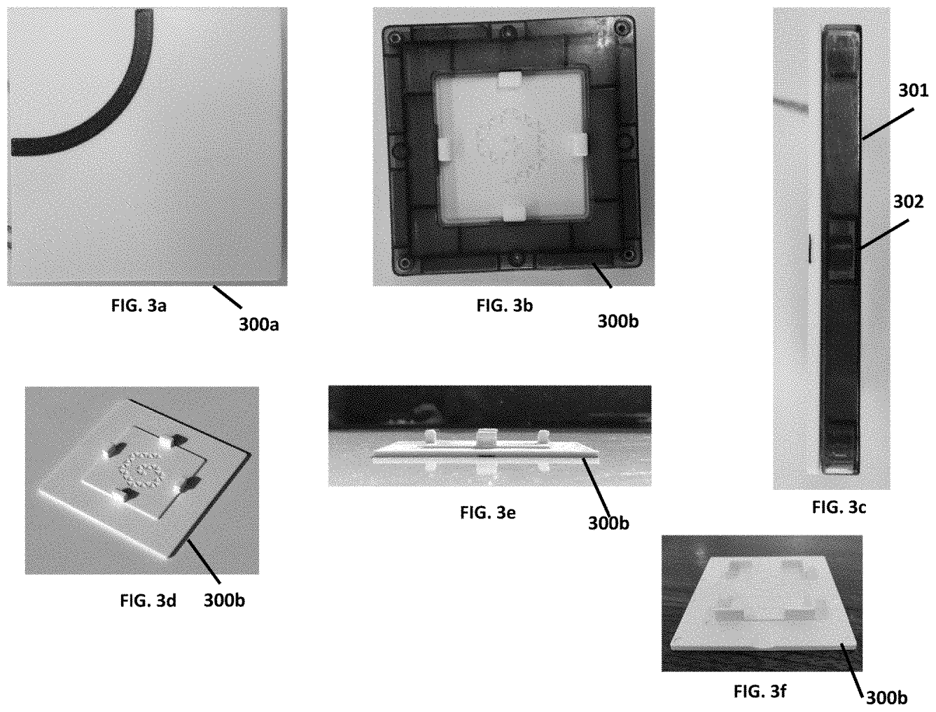

In one embodiment of the invention, an overlay is used in combination with a window tile to provide an element of a path for use with a line-follower robot. Shown in FIGS. 3a-3d is an overlay 300 for use with the present invention. The front of overlay 300, denoted as 300a in FIG. 3a, includes a curved line that can be used to make a line-follower robot change direction by 90 degrees. The back of overlay 300, denoted as 300b in FIGS. 3b, 3d and 3e, includes tabs for snapping the overlay into a magnetic window tile. As shown in these figures, the back of overlay 300 can include four symmetrical tabs that snap into recesses in window tile 200, such that overlay 300 is securely fastened to window tile 300. FIG. 3f depicts an alternative tab arrangement for the back of overlay 300, where the tabs are disposed at the corners that are configured to snap into corresponding corners of an opening on the face of a window tile. Overlay 300 can be manufactured by 3D printing, injection molding or other methods known to those of skill in the art. The lines and codes can be introduced during the printing or molding process, or added to tile blanks using stickers, screen printing or other known techniques. FIG. 3c depicts a side view 301 of a window tile 201. As shown, embedded in the side of window tile 201 is a magnet 302. Magnet 302 can be, in embodiments, a conventional magnet comprising a magnetic material. Although FIG. 3c depicts a single magnet 302 on side 301, side 301 can have multiple magnets 302 embedded therein.

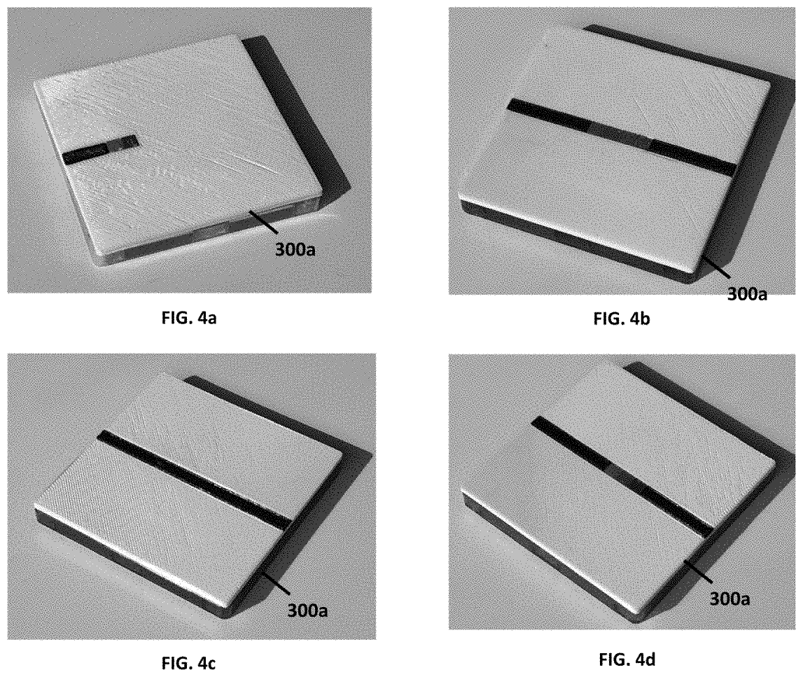

Overlay 300 can be imprinted with a wide variety of lines, curves, angles and codes. Representative overlays are shown in FIGS. 4a-4d. It should be noted that the lines can be provided in a variety of colors, not just black. For example, a robot may be programmed to turn red when following a red line or turn green when following a green line. For example, in FIG. 4a, overlay 300 (the front of which is denoted as 300a) is depicted with a pattern of three colors, which a robot can be programmed to detect and associate with a predetermined action, such as, for example, stopping, turning, or emitting a particular sound. FIGS. 4b and 4d depict different patterns on overlay 300, while overlay 300 depicted in FIG. 4c does not have a color pattern. Thus, a line-following robot traversing overlay 300 in FIG. 4c would tend to proceed over the overlay to a subsequent window tile. Moreover, since the tiles can be rearranged in virtually unlimited configurations, paper and markers are no longer required. In addition, the magnets embedded in the magnetic tiles cause the tiles to effectively self-align, making rearrangement of the tiles particularly hassle-free.

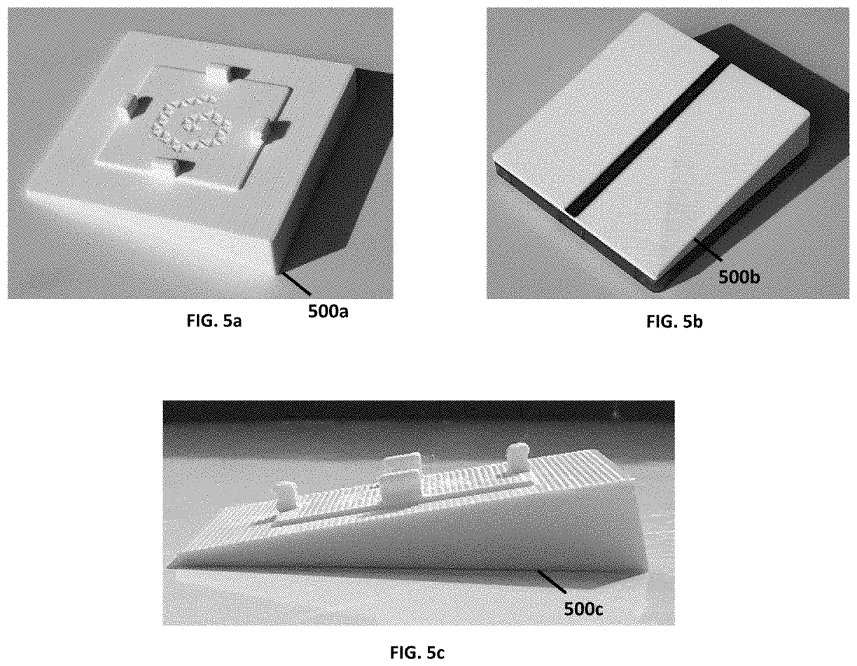

Furthermore, the overlays need not be flat. As shown in FIGS. 5a-5c, the overlays can be thicker at one end, thus, forming a ramp and allowing robotic projects to extend into three dimensions. FIG. 5a depicts a bottom view of an inclined overlay 500 (denoted as 500a). As shown, overlay 500 is thicker at the right end as depicted. Overlay 500 has on its bottom four tabs that can be fastened to a window tile 201. As with overlay 300, inclined overlay 500 can also include more or less than four tabs. FIG. 5b depicts a top view 500b of inclined overlay 500. As shown, a single line pattern is drawn or molded on the top of inclined overlay 500, which enables a line-following robot to traverse inclined overlay 500 and continue to a subsequent window tile 201. As with overlay 300, inclined overlay 500 can also include different line and color patterns, which can cause a line-following robot to turn, stop, emit a sound, or perform any predetermined action the robot is capable of. Furthermore, to the extent that additional rigidity is required when extending designs in three dimensions, connectors of the type disclosed in U.S. Appl. No. 62/758,775 can be used in conjunction with the instant invention.

FIG. 5c depicts a side view 500c of inclined overlay 500, which demonstrates the angle of incline of the overlay. As shown, overlay 500 is thinner at the left end as depicted. Thus, a line-following robot that encounters inclined overlay 500 from the thinner side would traverse a path in three dimensions by traveling upward as inclined overlay 500 is traversed. On the other hand, if a line-following robot encounters overlay 500 from the thicker side, then the robot would traverse a path in three dimensions by traveling downward as inclined overlay 500 is traversed. Many patterns can be drawn on overlay 500 to achieve desired behavior of a line-following robot, all of which are within the scope of the present invention.

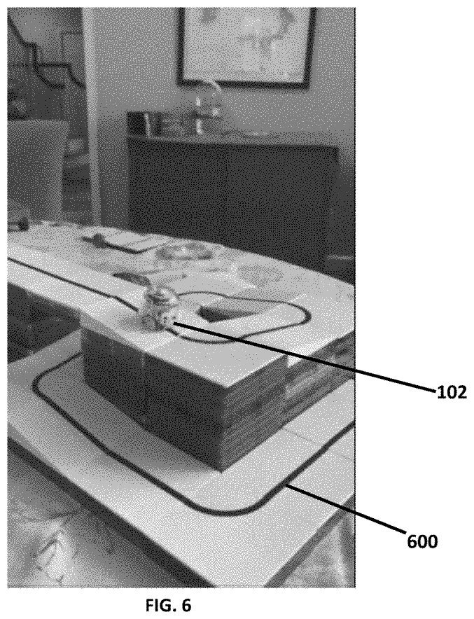

FIG. 6 is an exemplary track 600 that can be assembled using the tiles and methods of the present invention. As shown, an assortment of tile overlays can have depicted thereon: (1) straight lines; (2) right curves; and (3) codes. Further, as shown, track 600 includes three-dimensional pathway through the use of inclined overlays. In the figure, line-following robot 102 is shown traversing an inclined overlay that bridges two flat overlays. Further, in another embodiment, rather than making use of window tiles and overlays, specially constructed magnetic tiles can be used to incorporate the above elements (e.g., lines, curves, codes, ramps) into a single structure.

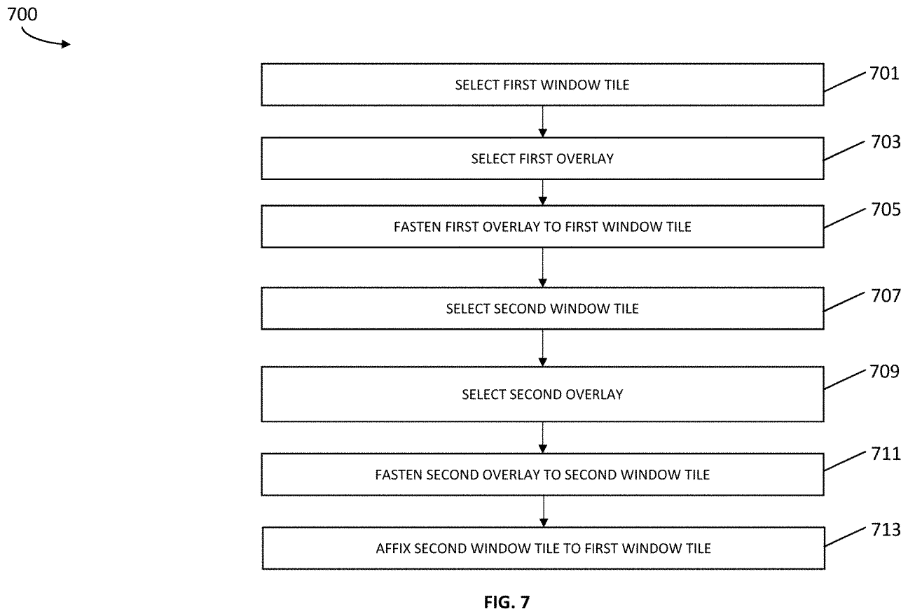

FIG. 7 depicts a flow diagram of an exemplary method 700 of constructing a path to be followed by a robot configured for two-dimensional motion. The robot is configured to perceive one or more visual indicators while in motion. At step 701, a first window tile is selected, such as window tile 201 depicted in FIG. 2. At step 703, a first overlay is selected, where the first overlay has a first surface that has printed thereon a first set of one or more visual indicators, such as, for example a line or curve.

At step 705, the first overlay to the first window tile by, for example, snapping the bottom of the first overlay into a depression having receptacles on the top of the first window tile.

Next, at step 707, a second window tile is selected. At step 709, a second overlay is selected, where the second overlay, like the first overlay, has a surface that has printed thereon a second set of one or more visual indicators, such as a line or curve. At step 711, the second overlay is fastened to the second window tile in a manner similar to the first overlay and window tile.

Next, at step 713, the first window tile is affixed to the second window tile such that the first and second set of visual indicators form a path that is capable of being perceived by the robot as the robot moves on the over the first and second surfaces of the first and second overlays. The window tiles may, in embodiments, be affixed to one another by placing magnetic edges of the window tiles adjacent to one another such that the two edges are magnetically attracted.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A robotic system comprising:
a robot configured to move in two dimensions;
a plurality of window tiles, each having fastened thereon an overlay, wherein each overlay has a surface on which is printed one or more corresponding visual indicators,
wherein, when the robot is further configured to sense the one or more visual indicators printed on the surface of the overlay as the robot moves over the surface of the overlay and, in response to sensing the one or more visual indicators, perform a predetermined action.

2. The system of claim 1, wherein each of the plurality of window tiles has four outer sides, each outer side having configured thereon one or more magnets such that, when a pair of window tiles are placed in proximity to one another, the pair of window tiles are magnetically attracted to one another.

3. The system of claim 2, wherein at least one of the overlays has printed on its surface a straight line, and wherein, when the robot travels over the surface of the at least one of the overlays, the robot is further configured to sense the straight line and, in response to the sensing, move along the straight line.

4. The system of claim 2, wherein at least one of the overlays has printed on its surface a curved line, and wherein, when the robot travels over the surface of the at least one of the overlays, the robot is further configured to sense the curved line and, in response to the sensing, execute a turn to follow the curved line.

5. The system of claim 2, wherein at least one of the overlays has printed on its surface a color pattern, and wherein, when the robot travels over the surface of the at least one of the overlays, the robot is further configured to sense the color pattern and, in response to the sensing, execute one of a plurality of predetermined actions.

6. The system of claim 5, wherein the plurality of predetermined actions includes stopping, speeding up, slowing down, reversing motion, or emitting a sound.

7. The system of claim 2, wherein at least one of the overlays has a first thickness at a first end and a second thickness at a second end, wherein the second thickness exceeds the first thickness, and wherein, when the robot travels over the surface of the at least one of the overlays, the robot moves in three dimensions.

8. The system of claim 2, wherein one or more of the plurality of window tiles has a surface on which is integrated one or more visual indicators.

9. The system of claim 8, wherein at least one of the plurality of window tiles has integrated on its surface a straight line, and wherein, when the robot travels over the surface of the at least one of the window tiles, the robot is further configured to sense the straight line and, in response to the sensing, move along.

10. The system of claim 9, wherein at least one of the window tiles has integrated on its surface a curved line, and wherein, when the robot travels over the surface of the at least one of the window tiles, the robot is further configured to sense the curved line and, in response to the sensing, execute a turn to follow the curved line.

11. The system of claim 1, wherein each of the plurality of overlays has a bottom surface on which is configured a plurality of tabs that are configured to be fastened to a receptacle on a corresponding surface of a window tile.

12. A method of constructing a path to be followed by a robot configured for two-dimensional motion and configured to perceive one or more visual indicators while in motion, the method comprising:
selecting a first window tile;
selecting a first overlay, the first overlay having a first surface that has printed thereon a first set of one or more visual indicators;
fastening the first overlay to the first window tile;
selecting a second window tile;
selecting a second overlay, the second overlay having a second surface that has printed thereon a second set of one or more visual indicators;
fastening the second overlay to the second window tile;
affixing the first window tile to the second window tile such that the first and second set of visual indicators form a path that is capable of being perceived by the robot as the robot moves on the over the first and second surfaces of the first and second overlays.

13. The method of claim 12, wherein fastening the first overlay to the first window tile comprises inserting one or more tabs on a bottom surface of the first overlay to one or more corresponding receptacles in a depression on a top surface of the window tile.

14. The method of claim 12, wherein affixing the first window tile to the second window tile comprises placing a first edge of the first window tile adjacent to a second edge of the second window tile, wherein the first and second edges have embedded thereon one or more magnets.

15. The method of claim 14, wherein the first overlay has a first thickness at a first end and a second thickness at a second end, the second thickness being greater than the first thickness, wherein, when the robot traverses the first overlay, the robot moves in three dimensions.
